(19) United States
(12) Patent Application Publication
(10) Pub. No.: US 2014/0129978 A1
(43) Pub. Date: May 8, 2014

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Tadahiro OISHI, Kanagawa (JP)

(73) Assignee: FUJI XEROX CO., LTD., Tokyo (JP)

(21) Appl. No.: 13/902,481

(22) Filed: May 24, 2013

(30) Foreign Application Priority Data
Nov. 7, 2012 (JP) 2012-245255

(51) Int. Cl. G06F 3/0482

(52) U.S. Cl. CPC G06F 3/0482
USPC 715/810

(57) ABSTRACT

An information processing apparatus includes a holding unit that holds parameters used in execution of a function for a plurality of items; a determining unit that determines whether a predetermined relationship is established between the parameters of different items; and a display controller that controls a display so as to display the parameters. The display controller causes the display to display a parameter determined not to have the predetermined relationship with a parameter of another item in a first mode. If a first parameter of a first item is selected by a user and is held and the determining unit determines that the predetermined relationship is established between the first parameter and a second parameter of a second item held by the holding unit, the display controller causes the display to display the first parameter in the first mode and to display the second parameter in a second mode.

### CROSS-REFERENCE TO RELATED APPLICATIONS

This application is based on and claims priority under 35 USC 119 from Japanese Patent Application No. 2012-245255 filed Nov. 7, 2012.

### BACKGROUND

### Technical Field

The present invention relates to an information processing apparatus, an information processing method, and a non-transitory computer readable medium.

### SUMMARY

According to an aspect of the invention, there is provided an information processing apparatus including a holding unit that holds parameters used in execution of a function for a plurality of items; a determining unit that determines whether a predetermined relationship is established between the parameters of different items; and a display controller that controls a display so as to display the parameters. The display controller causes the display to display a parameter determined by the determining unit not to have the predetermined relationship with a parameter of another item held by the holding unit in a first mode. If a first parameter of a first item is selected by a user and is held by the holding unit and the determining unit determines that the predetermined relationship is established between the first parameter and a second parameter of a second item held by the holding unit, the display controller causes the display to display the first parameter in the first mode and to display the second parameter in a second mode different from the first mode.

### BRIEF DESCRIPTION OF THE DRAWINGS

Exemplary embodiments of the present invention will be described in detail based on the following figures, wherein:

FIG. 1 illustrates the entire configuration of a book binding system;

FIG. 2 is a block diagram illustrating an exemplary hardware configuration of a book binding apparatus;

FIG. 3 is a block diagram illustrating an exemplary hardware configuration of a user apparatus;

FIG. 4 is a block diagram illustrating an exemplary functional configuration of the user apparatus;

FIG. 5 illustrates an exemplary selection image;

FIG. 6 illustrates an exemplary parameter list;

FIG. 7 illustrates an exemplary competition defining table;

FIGS. 8A to 8D illustrate exemplary modes of a parameter;

FIGS. 9A to 9C illustrate exemplary display modes of parameters that compete with each other;

FIG. 10 illustrates an example of the parameter list;

FIG. 11 illustrates an exemplary notification image;

FIG. 12 is a flowchart illustrating an exemplary operational process in a selection assisting process;

FIG. 13 illustrates another example of the selection image;

FIG. 14 illustrates another example of the selection image;

FIG. 15 illustrates another example of the selection image;

FIG. 16 illustrates another example of the selection image;

FIG. 17 illustrates an exemplary image indicating that a parameter is not held according to a modification;

FIG. 18 illustrates an exemplary collective list of the parameters of specified items according to another modification;

FIGS. 19A to 19C illustrate exemplary modes of a parameter according to another modification; and

FIG. 20 illustrates an exemplary selection image according to another modification.

### DETAILED DESCRIPTION

### Exemplary Embodiments

The present invention concerns assistance of parameter selection and is applied to various apparatuses. Exemplary embodiments in which the present invention is applied to a book binding system (a system for book binding) will herein be described with reference to the attached drawings.

### [Configuration]

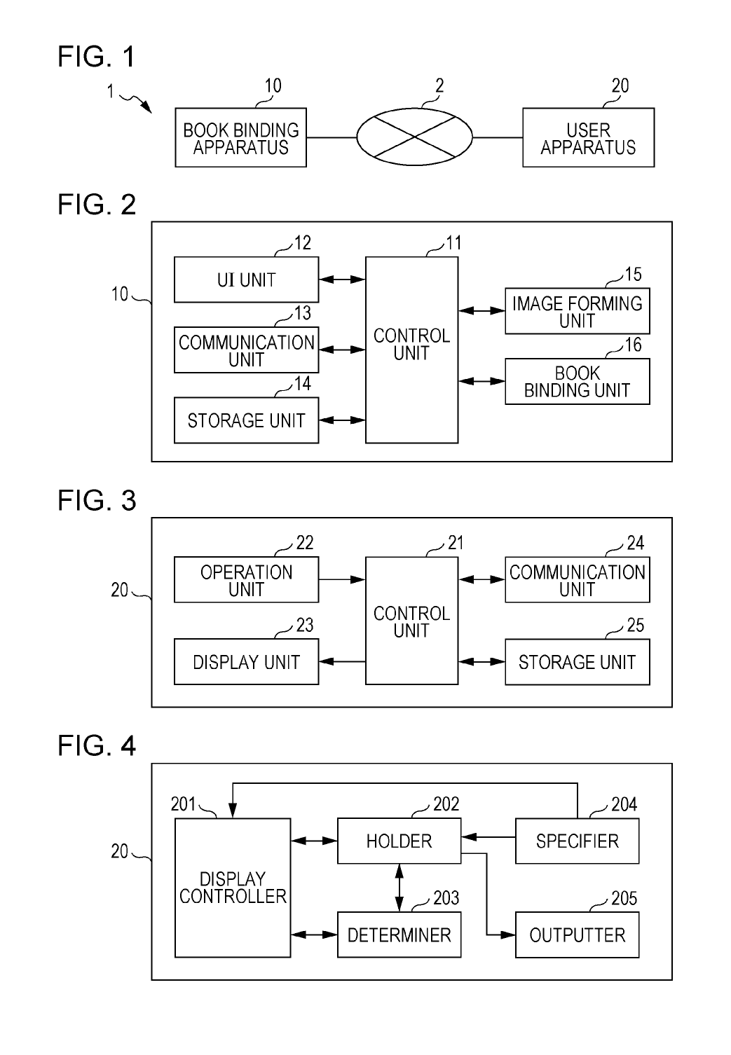

FIG. 1 illustrates the entire configuration of a book binding system 1. Referring to FIG. 1, the book binding system 1 includes a book binding apparatus 10, a user apparatus 20, and a network 2. The book binding apparatus 10 is an information processing apparatus that processes information, such as an image, forms an image on each sheet of paper, binds the sheets of paper on which the images are formed, and a cover is stuck with paste to bind a book (performs so-called case binding). The network 2 is, for example, an enterprise local area network (LAN). The book binding apparatus 10 and the user apparatus 20 are connected to the network 2. The user apparatus 20 is an information processing apparatus that processes information, such as an image, to hold parameters concerning the book binding and transmits data indicating an image on each page of a book to be bound to the book binding apparatus 10, along with the parameters that are held.

FIG. 2 is a block diagram illustrating an exemplary hardware configuration of the book binding apparatus 10. Referring to FIG. 2, the book binding apparatus 10 is a computer that includes a control unit 11, a user interface (UI) unit 12, a communication unit 13, a storage unit 14, an image forming unit 15, and a book binding unit 16. The control unit 11 includes a central processing unit (CPU), a read only memory (ROM), and a random access memory (RAM). The CPU executes programs stored in the ROM or the storage unit 14 by using the RAM as a working area to control the operation of each component in the book binding apparatus 10. The UI unit 12 includes, for example, a display screen and a touch panel superposed on the display screen. The UI unit 12 accepts a user's operation and announces information with an image that is displayed in the UI unit 12. The communication unit 13 includes an interface for transmission and reception of data to and from an external apparatus. Specifically, the communication unit 13 transmits data supplied from the control unit 11 to the external apparatus and supplies data received from the external apparatus to the control unit 11. The storage unit 14 includes a storage device, such as a hard disk drive (HDD), and stores data including the programs used by the control unit 11 to control each component.

The image forming unit 15 forms an image on a sheet of paper by, for example, an electrophotographic process. The sheet of paper on which the image is formed by the image forming unit 15 corresponds to a portion wrapped by a cover in a book which the book binding apparatus 10 is to bind (this portion is referred to as a “text”). As described above, the image forming unit 15 realizes a function to create the text (this function is referred to as a “text creating function”). One or more parameters that are set are used to realize the text creating function. The parameter is information used in the execution of a certain function (the text creating function in this case) and are selected by the user or are set in advance (so-called initial values). In the text creating function, information representing sheet sizes, such as “A4” and “B5”, is used as the parameters of an item “Sheet size of text.” Specifically, the image forming unit 15 forms an image on each sheet of paper having the size represented by the parameter to create the text.

The book binding unit 16 cuts the text created by the image forming unit 15 and binds the text that is cut to the cover with paste to bind the book. As described above, the book binding unit 16 realizes a function to finish a book (referred to as a “finishing function”). The parameters of items “How to stitch”, “How to cut”, and “Finishing size” are used in the finishing function. For example, the parameters of “Finishing size” include “A4” and “B5”, which each represent the size of the book that is bound. The book binding unit 16 performs the finishing so as to bind the book having the size represented by this parameter. As described above, in the book binding system 1, the parameters of multiple items are used in the execution of each function.

FIG. 3 is a block diagram illustrating an exemplary hardware configuration of the user apparatus 20. Referring to FIG. 3, the user apparatus 20 is a computer that includes a control unit 21, an operation unit 22, a display unit 23, a communication unit 24, and a storage unit 25. The control unit 21 includes a CPU, a ROM, and a RAM. The CPU executes programs stored in the ROM or the storage unit 25 by using the RAM as a working area to control the operation of each component in the user apparatus 20. The operation unit 22 includes an operator, such as a keyboard, and supplies operation data representing the content of a user's operation to the control unit 21 in response to the user's operation. The display unit 23 is a display that includes a display screen and displays an image indicated by image data supplied from the control unit 21. The communication unit 24 includes an interface for transmission and reception of data to and from an external apparatus. The communication unit 24 transmits data supplied from the control unit 21 to the external apparatus and supplies data received from the external apparatus to the control unit 21. The storage unit 25 includes a storage device, such as a HDD, and stores data including the programs used by the control unit 21 to control each component.

The user apparatus 20 performs a process to assist selection of parameters used in, for example, the text creating function and the finishing function described above on the basis of the above hardware configuration (this process is referred to as a “selection assisting process”). In addition, the user apparatus 20 transmits the parameter selected in the selection assisting process and the image data indicating an image on each page of a book to the book binding apparatus 10 to perform a process to request the book binding of the book binding apparatus 10 (this process is referred to as a “book binding requesting process”). Programs to perform the selection assisting process and the book binding requesting process are stored in the storage unit 25. The control unit 21 executes the programs to control each component in FIG. 1 in order to realize the following functions.

FIG. 4 is a block diagram illustrating an exemplary functional configuration of the user apparatus 20. Referring to FIG. 4, the user apparatus 20 includes a display controller 201, a holder 202, a determiner 203, a specifier 204, and an outputter 205.

The display controller 201 causes the display unit 23 to display the parameters. Specifically, the display controller 201 displays an image used by the user to select a parameter in the selection assisting process (this image is hereinafter referred to as a “selection image”).

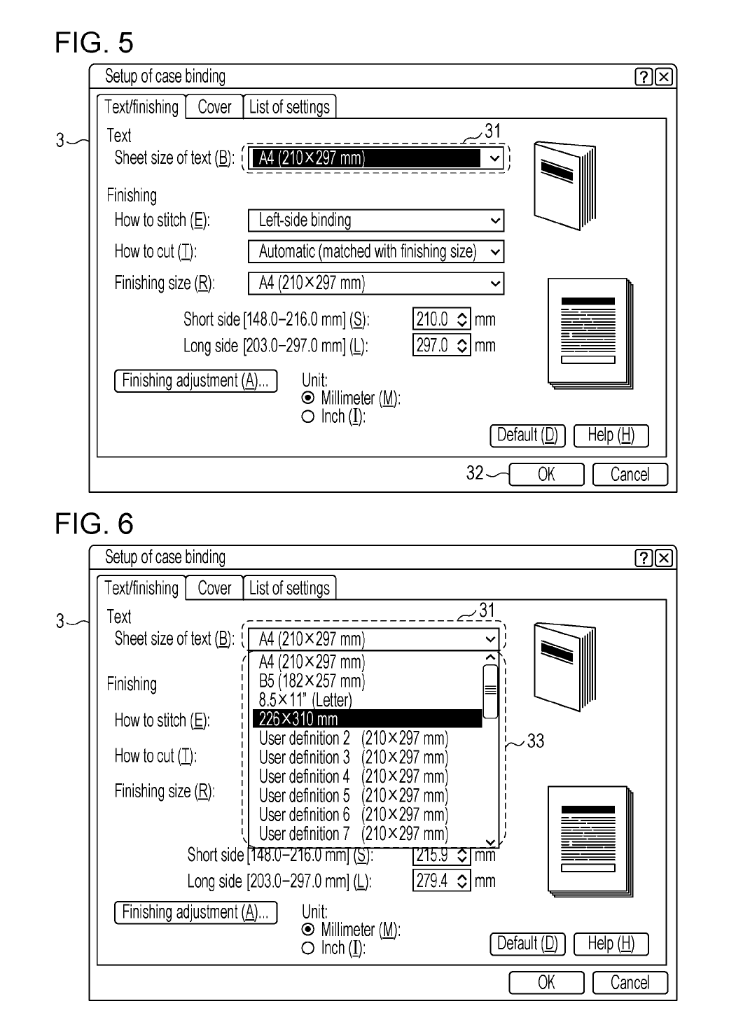

FIG. 5 illustrates an example of the selection image. A selection image 3 illustrated in FIG. 5 is used to select the parameters used in the text creating function and the finishing function. In the selection image 3, the items “Sheet size of text”, “How to stitch”, “How to cut”, and “Finishing size” are indicated and parameters “A4 (210×297 mm)”, “Left-side binding”, “Automatic (matched with finishing size)”, and “A4 (210×297 mm) are indicated for the above items, respectively. These parameters are used in the execution of the above functions (the text creating function and the finishing function). Each parameter used in the execution of each function is referred to as a “used parameter” and an area where each used parameter is displayed is referred to as a “used parameter display area.”

The display controller 201 is a function realized by cooperation of, for example, the control unit 21, the operation unit 22, and the storage unit 25. The storage unit 25 stores data about the selection image 3, the items, the parameters, and so on illustrated in FIG. 5. The control unit 21 reads out the data from the storage unit 25 to cause the display unit 23 to display the data. In addition, the control unit 21 causes the display unit 23 to display an image in response to a user's operation indicated by the operation data supplied from the operation unit 22. The display controller 201 performs the above control in the above manner.

Upon selection of, for example, a used parameter display area 31 where the parameters of the item “Sheet size of text” are displayed, among the used parameter display areas, in response to a user's operation, the display controller 201 displays a list of the parameters of the item. Such a list of the parameters of each item is hereinafter referred to as a “parameter list.”

FIG. 6 illustrates an example of the parameter list. In the example in FIG. 6, a parameter list 33 is displayed below the used parameter display area 31. The parameters including “A4 (210×297 mm)”, “B5 (182×257 mm)”, “8.5×11″ (Letter)”, “226×310 mm”, and “User definition 2 (210×297 mm)” are displayed in the parameter list 33. The display controller 201 displays a parameter (“226×310 mm” in this example) selected by the user with voided characters. Although the parameter “226×310 mm” is selected at this time, this parameter has not been made the used parameter (has not been made the parameter used in the execution of the functions). The display controller 201 supplies the parameter selected by the user and selection data indicating the corresponding item to the holder 202. In addition, the display controller 201 supplies display data indicating the parameter that is currently displayed to the determiner 203.

The specifier 204 specifies an item corresponding to the parameter. The item specified by the specifier 204 is hereinafter referred to as a “specified item” and an item that is not specified by the specifier 204 is hereinafter referred to as a “no-specified item.” A case in which two items “Sheet size of text” and “Finishing size” are the specified items will be described in the present exemplary embodiment. The specifier 204 is a function realized by cooperation of, for example, the control unit 21, the operation unit 22, and the storage unit 25. In this case, the items to be specified are stored in advance in the storage unit 25. The control unit 21 reads out these items from the storage unit 25 and specifies the items as the specified items. In response to an operation by the user to specify an item, the operation unit 22 supplies the operation data indicating the user's operation to the control unit 21. The operation data represents the item specified by the user. The control unit 21 specifies the item represented by the operation data that is supplied as the specified item. The specifier 204 specifies the item that is set in advance or specifies the item in response to a user's operation, as described above. After the specifier 204 specifies the item, the specifier 204 supplies specified data indicating the specified item to the display controller 201 and the holder 202.

The determiner 203 is a determining unit that determines whether a predetermined relationship is established between parameters of different items. The establishment of a predetermined relationship between parameters means that the parameters compete with each other in the present exemplary embodiment. For example, when the functions (for example, the text creating function and the finishing function described above) are not executed if a certain combination of parameters is selected, the parameters compete with each other. The case in which the functions are not executed corresponds to, in addition to a case in which the functions are not physically executed, a case in which the functions are physically executed but an error is caused and the apparatus is controlled so as to stop the functions because the execution of the functions is not recommended. In the book binding apparatus 10, a table defining combinations of parameters between which the predetermined relationship is established, that is, combinations of competing parameters is stored in the storage unit 25 (such a table is hereinafter referred to as a “competition defining table”).

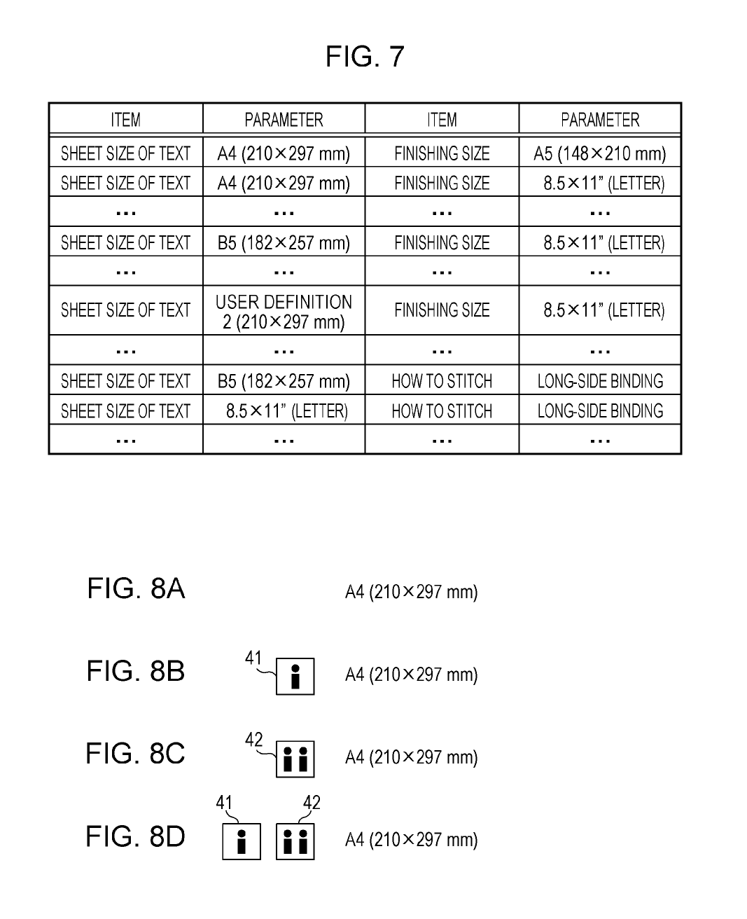

FIG. 7 illustrates an example of the competition defining table. The example in FIG. 7 indicates that the parameter “A4 (210×297 mm)” of the item “Sheet size of text” competes with the parameter “A5 (148×210 mm)” of the item “Finishing size.” Similarly, the example in FIG. 7 indicates that the parameter “A4 (210×297 mm)” of the item “Sheet size of text” competes with the parameter “8.5×11″ (Letter)” of the item “Finishing size”, the parameter “B5 (182×257 mm)” of the item “Sheet size of text” competes with the parameter “8.5×11″ (Letter)” of the item “Finishing size”, and the parameter “User definition 2 (210×297 mm)” of the item “Sheet size of text” competes with the parameter “8.5×11″ (Letter)” of the item “Finishing size.” In addition, the example in FIG. 7 indicates that the parameter “B5 (182×257 mm)” of the item “Sheet size of text” competes with the parameter “Long-side binding” of the item “How to stitch” and the parameter “8.5×11″ (Letter)” of the item “Sheet size of text” competes with the parameter “Long-side binding” of the item “How to stitch.”

The determiner 203 is a function realized by cooperation of the control unit 21 and the storage unit 25. The control unit 21 performs the above determination, for example, when the selection image is displayed by the display controller 201. Specifically, the control unit 21 extracts two parameters of different items from the parameters indicated by the display data supplied from the display controller 201 (that is, the parameters currently displayed). The control unit 21 determines that the parameters compete with each other if the combination of the two extracted parameters is included in the competition defining table illustrated in FIG. 7 and determines that the parameters do not compete with each other if the combination of the two extracted parameters is not included in the competition defining table illustrated in FIG. 7. The control unit 21 performs the determination for all the combinations of two parameters of different items.

The determiner 203 performs the determination in the above manner and supplies determination data indicating the result of the determination to the display controller 201 and the holder 202. If the determiner 203 determines that the predetermined relationship is established between parameters (parameters compete with each other in the present exemplary embodiment), the determiner 203 supplies the determination data indicating the parameters to the display controller 201 and the holder 202. If the determiner 203 determines that the predetermined relationship is not established between any parameters, the determiner 203 supplies the determination data indicating that the predetermined relationship is not established between any parameters to the display controller 201 and the holder 202.

The holder 202 is a holding unit that holds the parameters used in the execution of the functions (the used parameters described above) for multiple items. The holder 202 is a function realized by cooperation of, for example, the control unit 21, the operation unit 22, and the storage unit 25. The storage unit 25 has a predetermined area for each item and stores the used parameters in the areas. Such an area is hereinafter referred to as a “used parameter storage area.” In the book binding requesting process described above, the parameters stored in the used parameter storage area are transmitted to the book binding apparatus 10. In other words, the parameters stored in the used parameter storage area are used in the execution of the text creating function and the finishing function. The holder 202 holds the parameters used in the execution of the functions in the above manner. The parameters stored in the used parameter storage area when the selection image illustrated in FIG. 5 is displayed by the display controller 201 are held by the holder 202 as the so-called initial values.

The control unit 21 stores the parameters of an item selected by the user in the used parameter storage area of the item during a period in which the selection image is displayed by the display controller 201. Specifically, the control unit 21 determines whether an operation to determine the selection (referred to as a “determining operation”: for example, an operation to select a portion other than the used parameter display area 31 and the parameter list 33) is performed, for example, after the selection data is supplied from the display controller 201. If the determining operation is not performed even when a parameter is selected by the user, the control unit 21 does not store the parameter in the used parameter storage area. For example, in the example in FIG. 6, the parameter “226×310 mm” is not stored in the used parameter storage area because the determining operation has not been performed. The control unit 21 determines that the determining operation is performed if the operation data indicating the determining operation is supplied from the operation unit 22 and stores the parameter indicated by the selection data in the used parameter storage area of the item indicated by the selection data. The holder 202 holds the parameter selected by the user in the above manner.

When the holder 202 holds the parameter selected by the user, the holder 202 notifies the display controller 201 and the determiner 203 of the holding of the parameter selected by the user. Upon holding of the parameter selected by the user by the holder 202, the display controller 201 terminates the display of the parameter list and displays the parameter that is held in the used parameter display area. The parameter displayed in the used parameter display area is made the parameter used in the execution of the functions, that is, the used parameter.

In addition to the storage of the initial values and the parameter selected by the user described above, the holder 202 may update a parameter of a certain item, which is held, to another parameter of the item to hold the other parameter if the determiner 203 determines that the predetermined relationship is established between the parameter that is held and another parameter (the parameter that is held competes with another parameter in the present exemplary embodiment) (such a case is hereinafter simply referred to as a “competing case” for simplicity). In this case, the parameter is updated without a user's operation. The update that is automatically performed without a user's operation is hereinafter referred to as “automatic update.” The holder 202 automatically updates, for example, the used parameter of the no-specified item in the present exemplary embodiment.

The holder 202 continues to hold a parameter of the specified item, which is selected by the user and is held, without the automatic update as long as the parameter is not reset by the user even if the parameter competes with another parameter. The used parameter that is processed by priority after being held without the automatic update is hereinafter referred to as a “priority parameter.” The holder 202 holds the parameter of the specified item selected by the user as the priority parameter and holds the used parameter (that is, the initial value) of a predetermined specified item (for example, “Sheet size of text”) as the priority parameter when the selection image is displayed in the present exemplary embodiment, as described above.

The holder 202 does not hold the used parameter of the no-specified item as the priority parameter. The used parameter of the no-specified item, which is not processed by priority, is hereinafter referred to as a “no-priority parameter.” If the no-priority parameters compete with each other, the holder 202 automatically update either of the no-priority parameters. If the priority parameter competes with the no-priority parameter, the holder 202 automatically update the no-priority parameter while the holder 202 does not automatically update the priority parameter and continues to hold the priority parameter.

The holder 202 holds the parameter that is not held as the priority parameter, among the used parameters of the specified item, (such a parameter is hereinafter referred to as a “sub-priority parameter”) in the following manner in the present exemplary embodiment. If the sub-priority parameter competes with the no-priority parameter, the holder 202 automatically updates the no-priority parameter while the holder 202 does not automatically update the sub-priority parameter and continues to hold the sub-priority parameter. If the sub-priority parameters compete with each other, the holder 202 automatically update either of the sub-priority parameters.

The holder 202 supplies the parameters that are held to the outputter 205.

The outputter 205 is an output unit that outputs the parameters held by the holder 202. In the present exemplary embodiment, the outputter 205 transmits the parameters to the book binding apparatus 10. In addition, the outputter 205 transmits the image data indicating an image of each page of a book to be bound to the book binding apparatus 10, along with the parameters. The outputter 205 is a function realized by cooperation of the control unit 21, the communication unit 24, and the storage unit 25 and operates in the book binding requesting process described above.

The display controller 201 controls the display of the parameters on the basis of the determination data supplied from the determiner 203 and the specified data supplied from the specifier 204. In other words, the display controller 201 controls the display of the parameters on the basis of the result of the determination by the determiner 203 and the presence of the specification by the specifier 204. Specifically, the display controller 201 displays the parameters in three modes (referred to as a “first mode”, a “second mode”, and a “third mode”). The three modes in the present exemplary embodiment will now be described.

FIGS. 8A to 8D illustrate exemplary modes of a parameter. FIG. 8A illustrates the parameter “A4 (210×297 mm)” displayed in the first mode. In the first mode, only a character string representing the parameter is displayed. FIG. 8B illustrates the parameter displayed in the second mode. In the second mode, a square image 41 is added to the head of the character string representing the parameter. FIG. 8C illustrates the parameter displayed in the third mode. In the third mode, a square image 42 different from the image 41 is added to the head of the character string representing the parameter. FIG. 8D illustrates the parameter displayed in the second and third modes. In the example in FIG. 8D, both the image 41 and the image 42 are added to the head of the character string.

The display controller 201 displays the parameters determined by the determiner 203 that the predetermined relationship is not established with parameters of other items held by the holder 202 in the first mode. In other words, the display controller 201 displays the parameters that do not compete with the other used parameters in the first mode. The parameters displayed in this case include both the used parameter and the parameters displayed in the parameter list. For example, the display controller 201 displays all the parameters in the first mode in the example in FIG. 5 because no used parameter competes with the used parameters of the other items. The display controller 201 displays all the parameters in the first mode in the example in FIG. 6 because the parameters in the parameter list 33 do not compete with the used parameters of the other items (“How to stitch”, “How to cut”, and “Finishing size” in the example in FIG. 6). The display controller 201 displays the parameters that do not compete with each other in the first mode as the initial values when the selection image is displayed, that is, before the selection by the user is performed.

How to control the display when a certain parameter of a certain item is selected by the user and is held by the holder 202 will now be described. The parameter held in response to a user's operation is hereinafter referred to as a “first parameter” of a “first item.” The display controller 201 displays the first parameter in the first mode if the predetermined relationship is not established between the first parameter and a parameter of another item held by the holder 202 (that is, the used parameter of another item: hereinafter referred to as a “second parameter” of a “second item”) (if the first parameter does not compete with the second parameter). In contrast, if the determiner 203 determines that the predetermined relationship is established between the first parameter and the second parameter (the first parameter competes with the second parameter), the display controller 201 controls the display in different manners depending on whether each of the first item and the second item is the specified item.

If both the first item and the second items are the specified items, the display controller 201 displays the first parameter (which is the priority parameter) in the first mode and displays the second parameter in the second mode. If the first item is the specified item and the second item is the no-specified item, the display controller 201 displays the first parameter (which is the priority parameter) in the first mode and displays the second parameter in the third mode. If both the first item and the second item are the no-specified items, the display controller 201 displays both the first parameter and the second parameter in the third mode. If the second parameter is the sub-priority parameter even when the first item is the no-specified item and the second item is the specified item, the display controller 201 displays both the first parameter and the second parameter in the third mode. As described above, in the book binding system 1, the image 41 in the second mode indicates that the parameter is of the specified item and the parameter has the predetermined relationship with the priority parameter (the parameter competes with the priority parameter). The image 42 in the third mode indicates that the predetermined relationship is established between the parameter and a parameter other than the priority parameter (the parameter competes with a parameter other than the priority parameter).

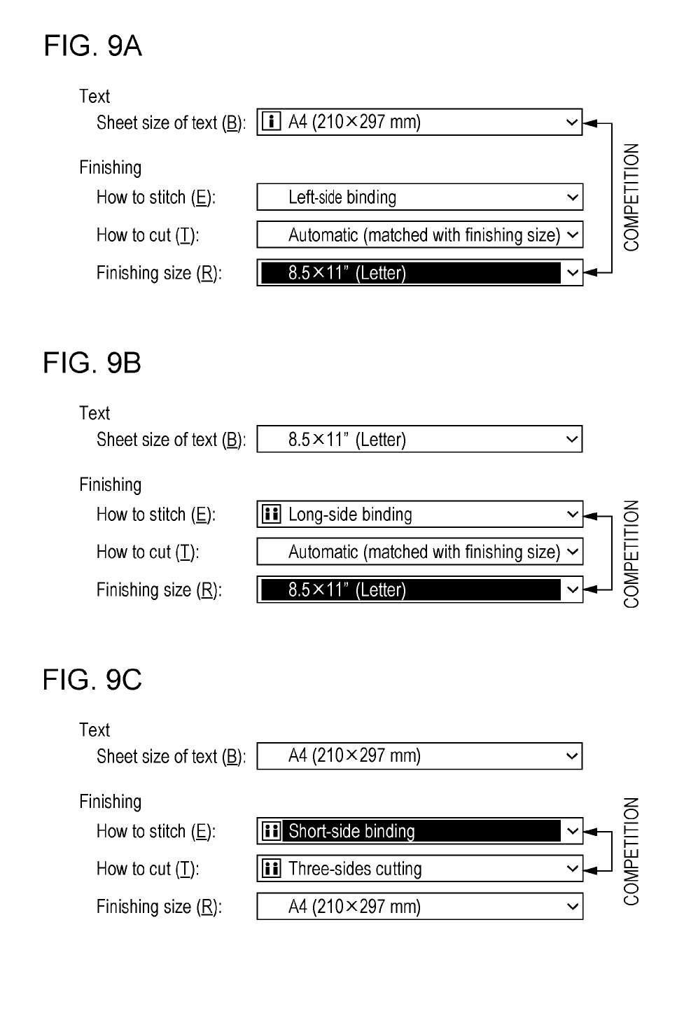

FIGS. 9A to 9C illustrate examples of the display modes of parameters that compete with each other. In the examples in FIGS. 9A to 9C, the parameters represented by voided character strings are the first parameters (the parameters that are selected by the user and that are held). In FIG. 9A, the first parameter “8.5×11″ (Letter)” of “Finishing size” competes with the second parameter “A4 (210×297 mm)” of “Sheet size of text.” Since both of the parameters are the parameters of the specified items, the first parameter “8.5×11″ (Letter)” is displayed in the first mode and the second parameter “A4 (210×297 mm)” is displayed in the second mode.

In FIG. 9B, the first parameter “8.5×11″ (Letter)” of “Finishing size” competes with the second parameter “Long-side binding” of “How to stitch.” Since the first parameter of the specified item competes with the second parameter of the no-specified item in this case, the first parameter “8.5×11″ (Letter)” is displayed in the first mode and the second parameter “Long-side binding” is displayed in the third mode. Although “8.5×11″ (Letter)” of “Sheet size of text” is displayed in the first mode in this example because “8.5×11″ (Letter)” of “Sheet size of text” does not compete with the first parameter, “8.5×11″ (Letter)” of “Sheet size of text” is displayed in the second mode if “8.5×11″ (Letter)” of “Sheet size of text” competes with the first parameter. If “8.5×11″ (Letter)” of “Sheet size of text” also competes with “Long-side binding”, “8.5×11″ (Letter)” of “Sheet size of text” is displayed in both the second and third modes (that is, both the image 41 and the image 42 are added to “8.5×11″ (Letter)” of “Sheet size of text”).

In FIG. 9C, the first parameter “Short-side binding” of “How to stitch” competes with the second parameter “Three-sides cutting” of “How to cut.” Since both the first parameter and the second parameter are the parameters of the no-specified item, both the first parameter and the second parameter are displayed in the third mode.

When the parameter list of the specified item illustrated in FIG. 6 is displayed, the display controller 201 displays the parameters competing with the priority parameter, among the parameters included in the parameter list, in the second mode.

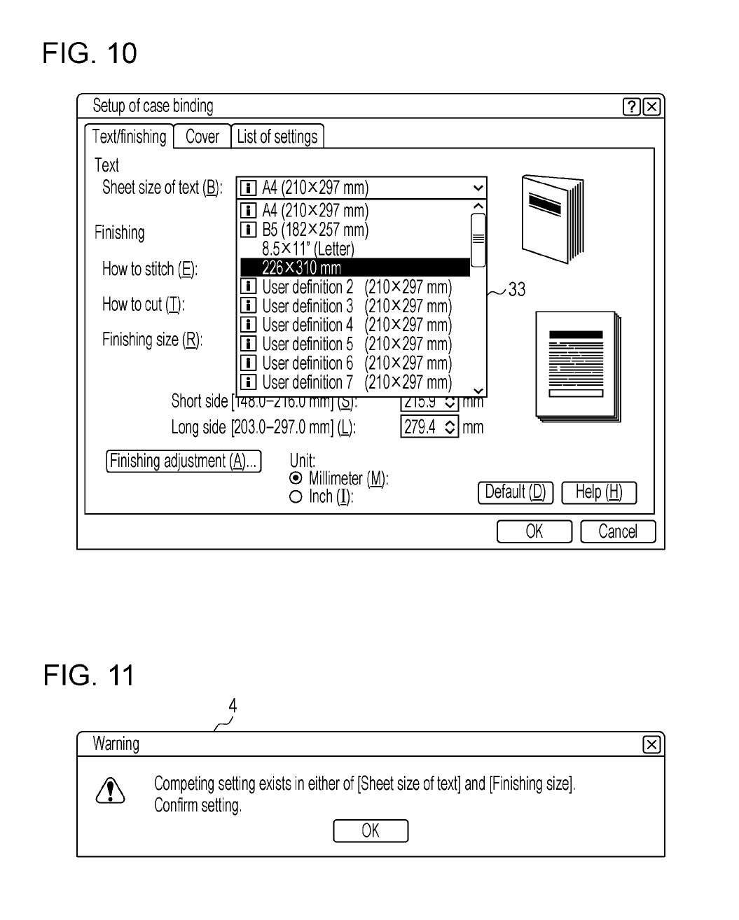

FIG. 10 illustrates an example of the parameter list. The parameter list 33 illustrated in FIG. 6 is illustrated in FIG. 10. In this example, the parameters of “Finishing size” are held as the priority parameters. The display controller 201 displays the parameters that compete with the priority parameter (for example, “A4 (210×297 mm)”), among the parameters of “Sheet size of text”, in the second mode and displays the parameters that do not compete with the priority parameter (for example, “8.5×11″ (Letter)”) in the first mode. In the display of the parameter list of the second item, the display controller 201 displays the parameters determined by the determiner 203 not to establish the predetermined relationship with the first parameter in the first mode and displays the parameters determined by the determiner 203 to establish the predetermined relationship with the first parameter in the second mode, as described above.

As described above, the used parameters displayed in the first mode by the display controller 201 include the parameters that do not compete with any of the other used parameters and the priority parameter. The former parameters may be updated without a user's operation by the automatic update performed by the holder 202 if the parameters are not the priority parameters. In contrast, the holder 202 continues to hold the latter parameter, that is, the priority parameter that is determined by the determiner 203 to establish the predetermined relationship but is displayed in the first mode by the display controller 201 unless the parameter is reset by the user.

When a parameter displayed in the second mode is selected from the parameter list by the user, the display controller 201 displays the parameter in the first mode as the used parameter. This parameter is the priority parameter that is displayed in the first mode even if the parameter competes with another parameter. In contrast, the display controller 201 displays the priority parameter that has been displayed in the first mode in the second mode as a parameter of the specified item competing with a new priority parameter. The parameter of the specified item, which is later selected by the user, is processed as the priority parameter in the present exemplary embodiment, as described above.

In response to an operation to terminate the parameter selection by the user (referred to as a “termination operation”: an operation to press a “OK” button 32 in the example in FIG. 5), the display controller 201 terminates the display of the image for operation to terminate the display of the parameters if the determiner 203 determines that no used parameter establishing the predetermined relationship with another used parameter exists (no used parameter competes with another used parameter). For example, when all the used parameters are displayed in the first mode, the display controller 201 terminates the display of the parameters because no used parameter competes with another used parameter.

When part of the used parameters is displayed in the third mode and the remaining used parameters are displayed in the first mode, the display controller 201 terminates the display in the following manner. In response to the termination operation, the holder 202 performs the automatic update described above. This causes the no-priority parameter competing with the priority parameter and the sub-priority parameter (the used parameter of the no-specified item, displayed in the third mode) to be automatically updated to the parameter that does not compete with the priority parameter and the sub-priority parameter. As a result, the competition of all the used parameters that have been displayed in the third mode is cleared and the used parameters are displayed in the first mode. The display controller 201 terminates the display of the parameters because no used parameter competes with another used parameter after the automatic update by the holder 202.

In contrast, when any used parameter is displayed in the second mode when the termination operation is performed, the display controller 201 does not terminate the display of the parameters. This is because the used parameter displayed in the second mode is the sub-priority parameter and the automatic update is not performed for the sub-priority parameter. In this case, the display controller 201 displays an image (referred to as a “notification image”) for notifying the user of the remaining of the parameter of the specified item having the predetermined relationship with the priority parameter (competing with the priority parameter).

FIG. 11 illustrates an example of the notification image. A notification image 4 illustrated in FIG. 11 represents a character string “Competing setting exists in either of [Sheet size of text] and [Finishing size]. Confirm setting.”

### [Operation]

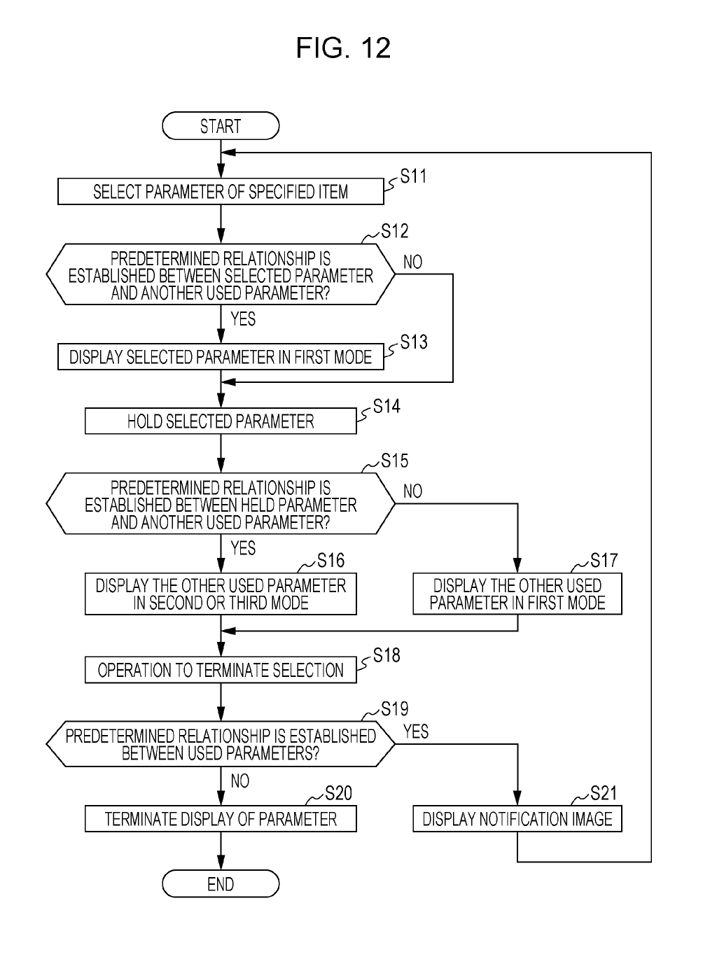

The user apparatus 20 performs the selection assisting process on the basis of the above configuration. An exemplary operation of the user apparatus 20 in the selection assisting process when the priority parameter competes with the sub-priority parameter will now be described with reference to FIG. 12.

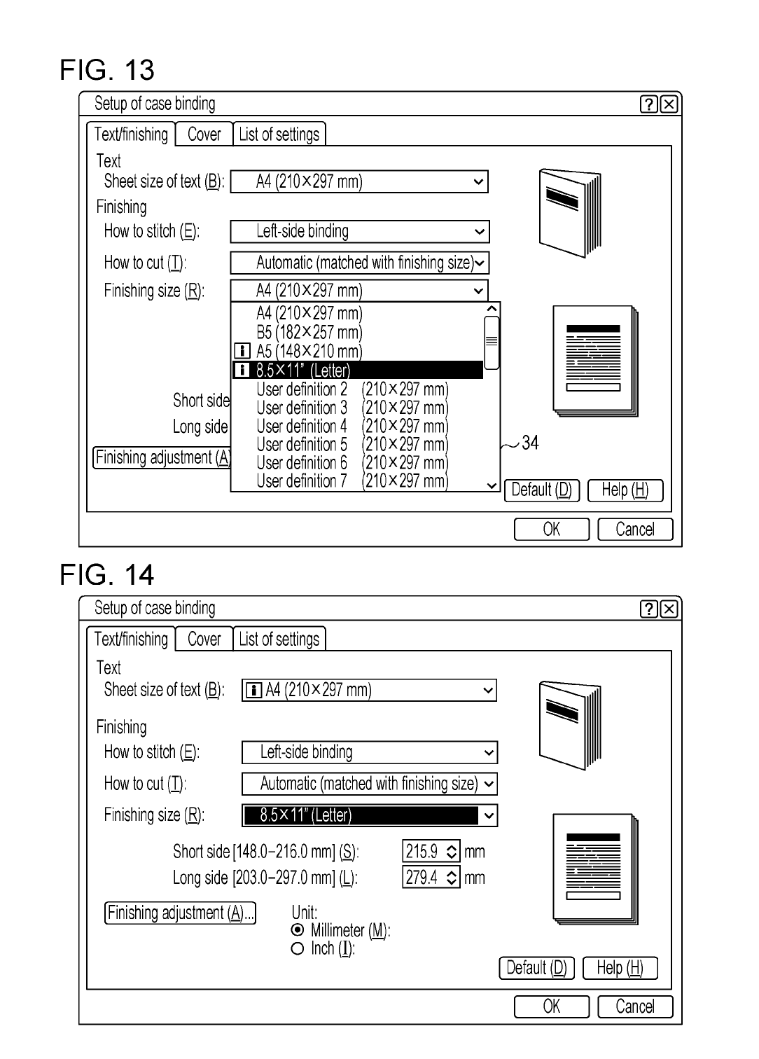

FIG. 12 is a flowchart illustrating an exemplary operational process of the user apparatus 20 in the selection assisting process. The selection assisting process is started upon display of the selection image in response to a user's operation. It is assumed in the example in FIG. 12 that the used parameter of “Sheet size of text” is made the priority parameter when the selection image is displayed. Referring to FIG. 12, in Step S11, the user apparatus 20 displays the parameter list of the specified item in response to a user's operation and any of the parameters is selected from the parameter list in response to a user′ operation. An example of the selection image displayed at this time is illustrated in FIG. 13.

FIG. 13 illustrates an example of the selection image. In the example in FIG. 13, “A4 (210×297 mm)” of “Sheet size of text” is made the priority parameter and a parameter list 34 of “Finishing size”, which is also the specified item, is displayed. Since “A5 (148×210 mm)” and “8.5×11” (Letter)“, among the parameters in the parameter list 34, compete with the priority parameter, “A5 (148×210 mm)” and “8.5×11” (Letter)” are displayed in the second mode and the remaining parameters are displayed in the first mode. In this example, “8.5×11″ (Letter)” is selected.

In Step S12, the user apparatus 20 determines whether the selected parameter establishes the predetermined relationship with another used parameter (competes with another used parameter in the present exemplary embodiment). If the selected parameter competes with another parameter, the selected parameter is displayed in a mode other than the first mode (in the second mode in the example in FIG. 13) when it is displayed in the parameter list 34. If the user apparatus 20 determines that the selected parameter establishes the predetermined relationship with another used parameter (YES in Step S12), in Step S13, the user apparatus 20 displays the selected parameter in the first mode, which is changed from the mode in which the selected parameter has been displayed. In Step S14, the user apparatus 20 holds the selected parameter. Since the parameter of the specified item, which is later selected, is processed as the priority parameter in the present exemplary embodiment, the parameter of the specified item selected in Step S11 is held as the priority parameter in Step S14 even if the parameter has the predetermined relationship with the previous priority parameter. If the user apparatus 20 determines that the selected parameter does not establish the predetermined relationship with another used parameter (NO in Step S12), the selected parameter has been displayed in the first mode. In this case, the process skips Step S13 and goes to Step S14. The parameter held in Step S14 is the first parameter of the first item, described above.

In Step S15, the user apparatus 20 determines whether the predetermined relationship is established between the parameter held in Step S14 and another used parameter (the parameter held in Step S14 competes with another used parameter). If the user apparatus 20 determines that the predetermined relationship is established between the parameter held in Step S14 and another used parameter (the parameter held in Step S14 competes with another used parameter) (YES in Step S15), in Step S16, the user apparatus 20 displays the other used parameter in the second mode or the third mode. Specifically, the user apparatus 20 display the other used parameter in the second mode if the other used parameter is the parameter of the specified item and displays the other used parameter in the third mode if the other used parameter is the parameter of the no-specified item. If the user apparatus 20 determines that the predetermined relationship is not established between the parameter held in Step S14 and another used parameter (the parameter held in Step S14 does not compete with another used parameter) (NO in Step S15), in Step S17, the user apparatus 20 displays the other used parameter in the first mode. The used parameter displayed in each of Step S16 and Step S17 is the second parameter of the second item described above. An example of the selection image displayed in Step S16 is illustrated in FIG. 14.

FIG. 14 illustrates an example of the selection image. In the example in FIG. 14, “8.5×11″ (Letter)” of “Finishing size” displayed in the first mode in Step S13 is held in Step S14 and “A4 (210×297 mm)” of “Sheet size of text” competing with the held parameter is displayed in the second mode in Step S16.

After Step S16 or Step S17, in Step S18, the user performs the termination operation (the operation to terminate the parameter selection). In Step S19, the user apparatus 20 determines whether the predetermined relationship is established between the used parameters (the used parameters compete with each other). If the user apparatus 20 determines that the predetermined relationship is not established between the used parameters (the used parameters do not compete with each other) (NO in Step S19), in Step S20, the user apparatus 20 terminates the display of the parameters. If the user apparatus 20 determines that the predetermined relationship is established between the used parameters (the used parameters compete with each other) (YES in Step S19), in Step S21, the user apparatus 20 displays the notification image, for example, the notification image illustrated in FIG. 11. Then, the process goes back to Step S11 to continue the operation. Steps S11, S14, and S20 are executed by the holder 202. Steps S12, S15, and S19 are executed by cooperation of the determiner 203. Steps S11, S13, S16, S17, S20, and S21 are executed by the display controller 201.

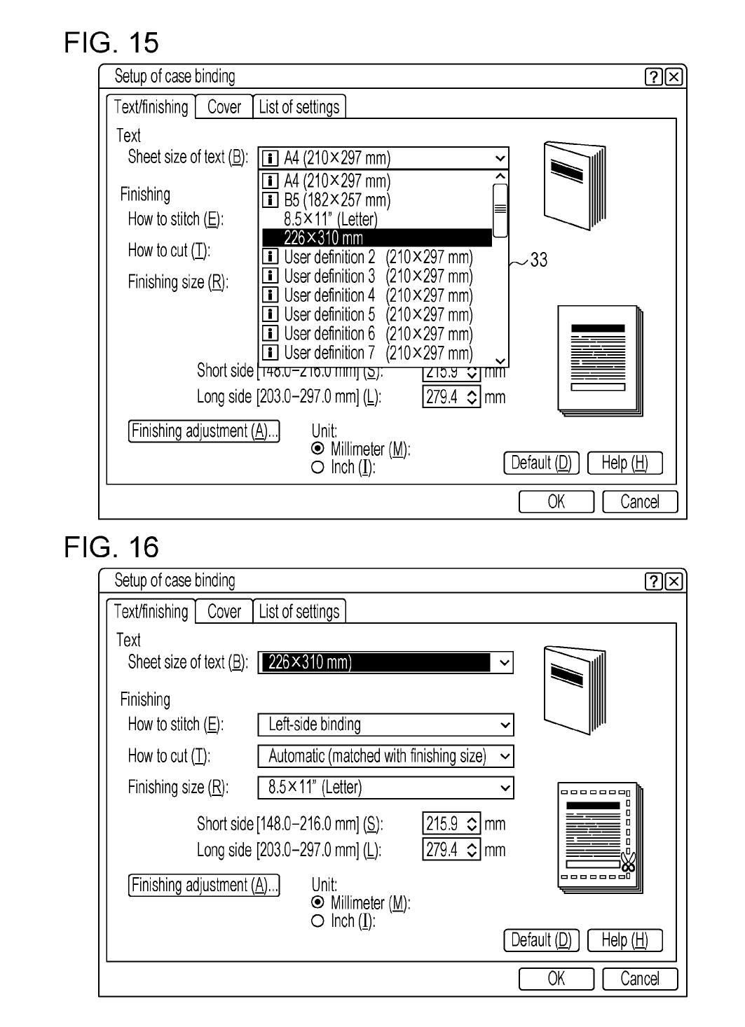

In Step S11 for the second time, for example, the user selects a parameter of the item (“Sheet size of text” in the above example) to which the used parameter displayed in the second mode belongs. An example of the selection image displayed at this time is illustrated in FIG. 15.

FIG. 15 illustrates an example of the selection image. In the example in FIG. 15, the parameter list 33 of “Sheet size of text”, which is the item to which “A4 (210×297 mm)” displayed in the second mode belongs, is displayed. The parameters that compete with “8.5×11″ (Letter)” of “Finishing size”, which is the priority parameter, are displayed in the second mode and the parameters that do not compete with “8.5×11″ (Letter)” of “Finishing size” are displayed in the first mode. In this example, “226×310 mm” displayed in the first mode is selected.

In response to the determining operation (the operation to determine the selection) in the state in FIG. 15, it is determined in Step S12 that “226×310 mm” that is selected does not compete with another used parameter and “226×310 mm” is held in Step S14 as the priority parameter. “226×310 mm” is displayed as the used parameter in the first mode in which “226×310 mm” has been displayed in the parameter list 33. An example of the selection image displayed at this time is illustrated in FIG. 16.

FIG. 16 illustrates an example of the selection image. In the example in FIG. 16, “226×310 mm”, which is the used parameter of “Sheet size of text”, is displayed in the first mode. In contrast, “8.5×11″ (Letter)” of “Finishing size” is determined not to compete with “226×310 mm” of “Sheet size of text”, which is the parameter that is held, in Step S15 and is displayed in the first mode in Step S17.

The user apparatus 20 displays each parameter depending on whether the predetermined relationship is established between the parameter and another parameter (whether the parameter competes with another parameter). In the user apparatus 20, the parameter that does not compete with another used parameter (referred to as a “non-competing parameter”) is displayed in the first mode. In other words, the used parameter displayed in the first mode is recognized by the user as the parameter that is to be actually used in the execution of the functions when the selection of the parameters is terminated, that is, as the parameter the use of which is determined (referred to as a “usage determined parameter”). In addition, since the priority parameter is displayed in the first mode regardless of the presence of the competition with another used parameter in the user apparatus 20, even the used parameter competing with another used parameter (referred to as a “competing parameter”) is recognized by the user as the usage determined parameter.

For example, when the user wants to use a parameter of a specified item that is selected in the execution of the functions, the display of the parameter in a mode other than the first mode because of the competition with another used parameter may cause the user not to determine which parameter is first selected while the user is updating other parameters displayed in modes other than the first mode. In this case, the user may erroneously update the parameter that is first selected.

In the present exemplary embodiment, the parameter of the specified item, which is selected by the user and is held, (the first parameter described above) is displayed in the first mode to cause the user to recognize the parameter as the usage determined parameter and to update a competing parameter other than the parameter in the clearance of the competition. According to the present exemplary embodiment, when the parameter is displayed depending on whether the predetermined relationship is established between the parameter and another parameter, the possibility that the user erroneously updates the selected parameter later is reduced, compared with the configuration in which the first parameter is displayed in a mode other than the first mode, and the user is capable of easily selecting a parameter.

In the present exemplary embodiment, the priority parameter is not automatically updated and is continued to be held unless the priority parameter is reset by the user. Accordingly, for the item to which the parameter that is selected by the user and is displayed in the first mode belongs, the functions are prevented from being executed by using the parameter that is not selected by the user. In addition, in the present exemplary embodiment, the used parameter that competes with the first parameter and that belongs to the specified item is displayed in the second mode and the used parameter that competes with the first parameter and that belongs to the no-specified item is displayed in the third mode. Since the used parameter of the specified item is not automatically updated, as described above, the user is capable of discriminating the second parameter for which the state in which the predetermined relationship is established with the first parameter is not cleared without the update by the user from the second parameter for which the above state is cleared without the update by the user in the present exemplary embodiment. Furthermore, in the present exemplary embodiment, since the specifier 204 specifies an item on the basis of a user's operation, the user specifies the item for which a user's operation is necessary to update the used parameter.

The user apparatus 20 does not terminate the selection of the parameter unless the user apparatus 20 determines in Step S19 that the predetermined relationship is not established between the used parameters. Accordingly, the functions are prevented from being executed in a state in which the predetermined relationship is established between any ones of the parameters. The user apparatus 20 displays the parameter having the predetermined relationship with the first parameter in the second mode when the list of the parameters of the second item is displayed. Accordingly, the user is capable of determining which parameter is to be selected in order to clear the state in which the predetermined relationship is established with the first parameter (the priority parameter). The user apparatus 20 does not hold the second parameter that is displayed in the second mode in the parameter list even if the second parameter is selected by the user and displays the image indicating that the selected parameter is not held. Accordingly, the user is prevented from erroneously selecting the second parameter for which the state in which the predetermined relationship is established with the first parameter (the priority parameter) is not cleared in the operation to clear the state.

### [Modifications]

While the invention is described in terms of some specific exemplary embodiments, it will be clear that this invention is not limited to these specific exemplary embodiments and that many changes and modifications will be obvious to those skilled in the art. Exemplary modifications will now be described. Combinations of the exemplary embodiment described above and the modifications described below may be adopted, if necessary.

### [First Modification]

Although the predetermined relationship corresponds to the competition between the parameters (the functions are prevented from being executed if the parameters are used) in the above exemplary embodiments, the predetermined relationship is not limited to this. For example, a combination of parameters in which the functions are executed but which is not recommended may be set in advance as the combination representing the parameters having the predetermined relationship. Alternatively, any combination of parameters may be set in advance as the combination representing the parameters having the predetermined relationship, regardless of the presence of the recommendation.

It is not necessary to set in advance the combination of parameters having the predetermined relationship. For example, a certain value may be allocated to each parameter (the area or the aspect ratio of a parameter representing a size), the values of the parameters may be compared with each other or the values of the parameters may be assigned to a certain expression to compare the calculated values, and it may be determined that the predetermined relationship is established between the parameters if a predetermined condition (for example, the value of one parameter does not exceed twice of that of the other one) is met. In sum, it is sufficient for the predetermined relationship to be determined in advance as the relationship representing the relationship between the parameters. Also in this case, the user apparatus 20 displays the parameters depending on whether the predetermined relationship is established with other parameters.

### [Second Modification]

Although the determiner 203 performs the determination of whether the predetermined relationship is established between parameters by using the table illustrated in FIG. 7 stored in the storage unit 25 in the above exemplary embodiments, the determination by the determiner 203 is not limited to the above one. For example, the table may be stored in an external apparatus and the determiner 203 may refer to the table stored in the external apparatus to perform the determination. Alternatively, the determiner 203 may compare the values allocated to the parameters or may compare the values calculated from the values allocated to the parameters, as in the manner described in the above modification, to perform the determination. It is sufficient for the determiner 203 to determine whether the predetermined relationship is established between parameters by any method.

### [Third Modification]

Although the user apparatus 20 processes the parameter of the specified item that is later selected by the user as the priority parameter in the above exemplary embodiments, the priority parameter is not limited to the above one. For example, the user apparatus 20 may process the parameter of the specified item that has been previously selected by the user as the priority parameter and may not select the parameters having the predetermined relationship with the priority parameter for the other items. In this case, the display controller 201 does not display the selected parameter as the used parameter even if the determining operation is performed when the parameter selected from the parameter list by the user (regardless of the specified item or the no-specified item) competes with the priority parameter. The holder 202 does not hold the parameter that is displayed in the second mode in the parameter list by the display controller 201 when the parameter is selected by the user.

When a parameter displayed in the second mode in the parameter list is selected, the display controller 201 displays an image indicating that the parameter is not made the parameter (the used parameter) used in the execution of the functions (the text creating function and the finishing function in the above exemplary embodiments).

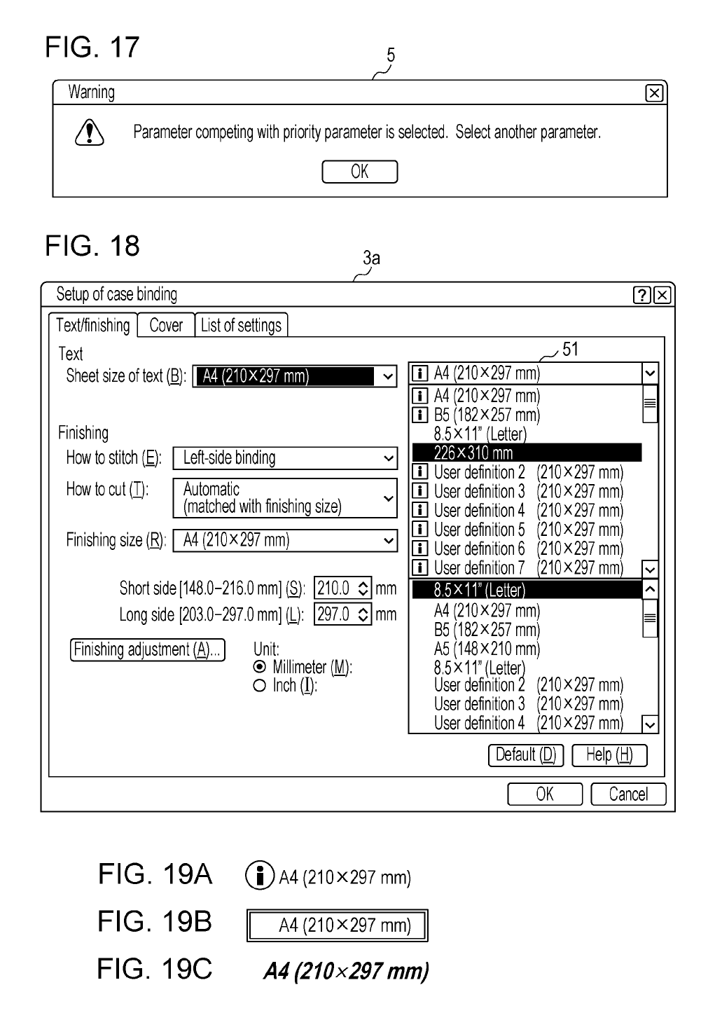

FIG. 17 illustrates an exemplary image indicating that a parameter is not held. An image 5 illustrated in FIG. 17 represents a character string “Parameter competing with priority parameter is selected. Select another parameter.” The user views the image to recognize that the selected parameter is not made the used parameter and selects another parameter. For example, the parameter list may be continued to be displayed even when the selection operation is performed to cause the user to recognize that the selected parameter is not made the used parameter. Accordingly, the parameter list is also an example of the image indicating that the parameter is not made the used parameter. In addition, in the user apparatus 20, the processing of the priority parameter may be cleared, for example, when the notification image is displayed by the display controller 201. This allows a parameter to be freely selected for the specified item other than the item to which the priority parameter belongs after the notification image is displayed. In this case, the priority parameter that is newly held has higher priority over the parameters of the other items.

### [Fourth Modification]

The holder 202 may hold the parameters on the basis of the rank determined for each item. In this case, when the determiner 203 determines that the predetermined relationship is established between the first and second parameters, the holder 202 holds the first parameter if the rank of the first item is made higher than that of the second item (the former case) and does not hold the first parameter if the rank of the first item is made lower than that of the second item (the latter case). A case in which the ranks are set for the specified item will now be described as a specific example. For example, when the second parameter has already been held as the priority parameter, the holder 202 holds the first parameter as the priority parameter if the first parameter of the first specified item of the higher rank is selected and does not hold the first parameter if the first parameter of the first specified item of the lower rank is selected. The second parameter is not made the priority parameter in the former case and is kept to be the priority parameter in the latter case. The display controller 201 displays the second parameter in the second mode in the former case and continues to display the second parameter in the first mode in the latter case.

In the user apparatus 20, the ranks of the items may be determined in accordance with the order selected by the user. For example, the rank of a certain item may be determined to be higher than the rank of the item for which the parameter is held by the holder 202 after the certain item.

Specifically, it is assumed that “Sheet size of text”, “How to stitch”, and “Finishing size” are the specified items and the user selects a parameter of “Sheet size of text.” The holder 202 holds the selected parameter as the first priority parameter. Then, it is assumed that the user selects a parameter of “How to stitch.” The holder 202 does not hold the parameter having the predetermined relationship with the first priority parameter but holds the parameter having the predetermined relationship with the parameter selected for “Finishing size” as the second priority parameter. When the user subsequently selects a parameter of “Finishing size”, the holder 202 holds the parameter that does not have the predetermined relationship with the first and second priority parameters as the third priority parameter.

Since only the parameters that are later selected and that do not have the predetermined relationship with the parameters that have been previously selected are selected in the above example, the sequential selection of the parameters by the user causes the parameters between which the predetermined relationship is not established to be held.

After the notification image is displayed in Step S21, the rank of the priority parameter may be returned to the original state before the priority parameter is selected, as in the above exemplary embodiments, or the rank of the priority parameter may be kept.

When the rank of each specified item is determined in the above manner, the selection in ascending order (referred to as a “first case”) may take a trouble to reset the parameter that has been previously selected if the predetermined relationship is established with a parameter of the item that is later selected. In contrast, since the selection in descending order (referred to as a “second case”) causes a parameter of the item of a lower rank having the predetermined relationship with a parameter of the selected item not to be held although being selected, it is easy to select the parameters that do not have the predetermined relationship, compared with the first case, thereby reducing the trouble to reset the parameter. According to the fourth modification, the understanding of the rank of each item by the user or the addition of the number representing the rank to the character string of each item by the display controller 201 allows the user to easily recognize the rank of the item from which a parameter is selected, compared with the case in which the parameters are held regardless of the ranks of the items, thereby reducing the probability that the user resets the parameter.

### [Fifth Modification]

Although the user apparatus 20 performs the selection assisting process in the above exemplary embodiments, the selection assisting process is not limitedly performed by the user apparatus 20 and may be performed by the book binding apparatus 10. In this case, the programs to perform the selection assisting process are executed by the control unit 11 in the book binding apparatus 10 in order for the book binding apparatus 10 to realize the functions illustrated in FIG. 4. The parameter selection by the user is assisted by the display of the selection image, such as the one illustrated in FIG. 5, by the UI unit 12. Although the information processing apparatus that performs the selection assisting process (the user apparatus 20) is separated from the apparatus that executes the functions by using the selected parameters (the book binding apparatus 10) in the above exemplary embodiments, one information processing apparatus (the book binding apparatus 10 of the fifth modification) may perform the selection assisting process and the execution of the functions by using the selected parameters.

The present invention is also applied to a system and an apparatus other than the book binding system. For example, the present invention may be applied to an information processing apparatus, such as an image forming apparatus, a facsimile apparatus, a scanner apparatus, or a network apparatus (for example, a router). In any case, the information processing apparatus realizes the functions illustrated in FIG. 4 to perform the selection assisting process. The information processing apparatus performs a process to request the execution of the functions of the corresponding apparatus, instead of the book binding requesting process described above, on the basis of the parameters held in the holder 202. The present invention is applied to the information processing apparatus that displays the parameters depending on whether the predetermined relationship is established between parameters of multiple items used in the execution of the functions and parameters of other items.

### [Sixth Modification]

Although the display controller 201 displays the parameters having the predetermined relationship with the first parameter in the second mode, as in the example in FIG. 10, also in the parameter list of the specified item in the above exemplary embodiments, the display of the parameters is not limited to this. For example, also when the display controller 201 displays the parameters in the parameter list in the first mode and the user selects a parameter that is displayed as the used parameter, the selected parameter is displayed in the second mode if the selected parameter has the predetermined relationship with the first parameter (the priority parameter). Accordingly, the user is capable of recognizing that the selected parameter has the predetermined relationship with the first parameter.

### [Seventh Modification]

Although the holder 202 terminates the parameter selection if the predetermined relationship is not established between the parameters that are held in Step S19 in FIG. 12 in the above exemplary embodiments, the termination of the parameter selection is not limited to the above one. For example, the holder 202 may terminate the parameter selection if the predetermined relationship is established between specific parameters. In this case, the specific parameters means, for example, a combination of parameters that have a disadvantage in the execution of the functions (for example, the book binding is roughly finished) but enables the execution of the functions. In addition, when the termination operation (the operation to terminate the parameter selection) is performed in Step S18, the holder 202 may not perform Step S19 and may terminate the parameter selection in Step S20. In this case, although an error may be notified by a function of the book binding apparatus 10 and the execution of the function may be stopped when the function is executed depending on the parameter having the predetermined relationship, the user may reset the parameter on the basis of the notification in such a case.

### [Eighth Modification]

Although the specifier 204 specifies part of the multiple items in the above exemplary embodiments, the specifier 204 may specify all the items or may specify no item. When the specifier 204 specifies all the items, the display controller 201 displays all the parameter having the predetermined relationship with the first parameter in the second mode. In contrast, when the specifier 204 specifies no item, the display controller 201 displays all the parameter having the predetermined relationship with the first parameter in the third mode. Furthermore, the user apparatus 20 may not include the specifier 204. In this case, the display controller 201 and the holder 202 operate on the assumption that all the items are the specified items to perform the operation in the case in which all the items are specified by the specifier 204.

Also in this case, the display of the first parameter in the first mode allows the user to recognize the parameter as the usage determined parameter and causes the user to update the competing parameters other than the parameter in the clearance of the competition. Accordingly, also in the eighth modification, as in the above exemplary embodiments, when the parameter is displayed depending on whether the parameter has the predetermined relationship with another parameter, the possibility that the user erroneously updates the selected parameter later is reduced, compared with the configuration in which the first parameter is displayed in a mode other than the first mode, and the user is capable of easily selecting a parameter.

### [Ninth Modification]

The selection image 3 illustrated in FIG. 5 and so on is only an example and the display controller 201 may display various selection images. For example, the display controller 201 may display only the parameter list 33 without displaying the used parameter display area 31, may display a radio button beside each parameter in the parameter list 33, and may cause the user to select a radio button to select the parameter corresponding to the radio button.

Alternatively, instead of the display of the parameter list of each item, the display controller 201 may display a collective list of the parameters of the specified items and may cause the user to select the priority parameter.

FIG. 18 illustrates an exemplary collective list of the parameters of the specified items. A selection image 3a illustrated in FIG. 18 includes a list 51 in which the parameters of “Sheet size of text” and “Finishing size”, which are the specified items, are collectively displayed. In the example in FIG. 18, the parameter “8.5×11″ (Letter)” of “Finishing size” is selected as the first parameter (the priority parameter) and the parameters of “Sheet size of text” having the predetermined relationship with the first parameter (competing with the first parameter) are displayed in the second mode. In this case, upon only resetting of the first parameter by the user, the display controller 201 displays the parameters of the specified item having the predetermined relationship with the first parameter that is newly selected (competing with the first parameter that is newly selected) in the second mode. In this example, the user is capable of easily comparing the parameters of the specified item having the predetermined relationship with the first parameter with the parameters before the first parameter is reset, compared with the case in which the display controller 201 does not display the parameters of the specified item in the list.

### [Tenth Modification]

The display controller 201 may display the parameters in modes other than the first, second, and third modes described above in the exemplary embodiments. For example, the display controller 201 may use the mode (the second mode in the exemplary embodiment) in which the image 41 illustrated in FIG. 8B is added to the head of each parameter as the first or third mode or may use the mode (the third mode in the exemplary embodiment) in which the image 42 illustrated in FIG. 8C is added to the head of each parameter as the first or second mode. In any case, it is sufficient to differentiate the first mode, the second mode, and the third mode from one another. Modes other than the first mode, the second mode, and the third mode will now be described with reference to FIGS. 19A to 19C.

FIGS. 19A to 19C illustrate exemplary modes of a parameter. Although both of the images 41 and 42 are square images, a circular image is added to the head of the parameter in the example in FIG. 19A. In the example in FIG. 19B, a rectangular image surrounding the parameter is added. The display controller 201 may vary the image displayed around the parameter to represent the modes, as in the manner in FIG. 19B. In the example in FIG. 19C, the font of the character string of the parameter is increased and is represented in a bold face and an italic face. The display controller 201 may vary the font and/or the style of the character string itself of the parameter (for example, in the bold face and/or the italic face) to represent the modes, as in the manner in FIG. 19C. Alternatively, the display controller 201 may vary the color and/or the size of the font or the image to represent the modes. Alternatively, the display controller 201 may add a character string “Update parameter so as not to compete with priority parameter” around the parameter, for example, around the parameter in the second mode or may add a character string “May be updated in termination of selection” around the parameter in the third mode. Also in these cases, it is sufficient to differentiate the first mode, the second mode, and the third mode from one another.

### [Eleventh Modification]

Although the display controller 201 does not differentiate the display of the specified items and the display of the no-specified items in the above exemplary embodiments, the display of the specified items and the display of the no-specified items may be differentiated.

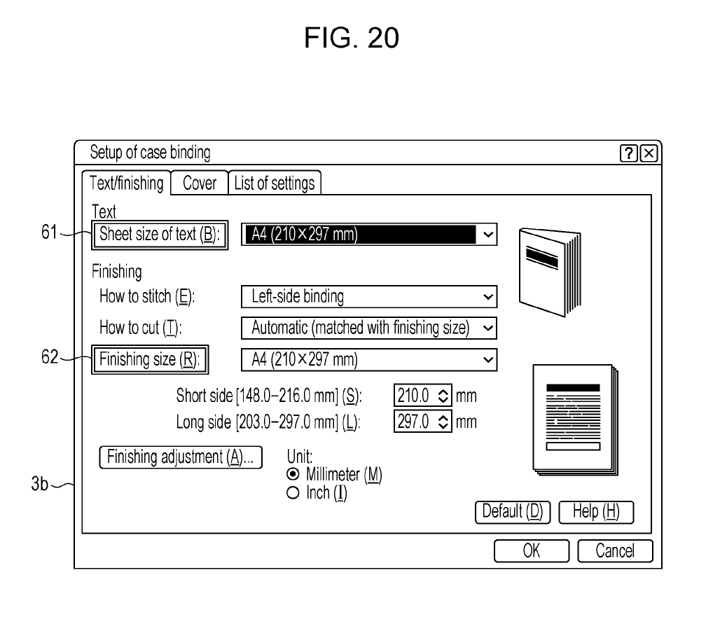

FIG. 20 illustrates an example of a selection image according to an eleventh modification. A selection image 3b illustrated in FIG. 20 includes an image 61 in which the character string “Sheet size of text”, which is the specified item, is surrounded by rectangles and an image 62 in which the character string “Finishing size”, which is the specified item, is surrounded by rectangles. In contrast, in the selection image 3b in FIG. 20, the character strings “How to stitch” and “How to cut”, which are the no-specified items, are not surrounded by rectangles. The selection image 3b is only an example and it is sufficient to differentiate the mode in which the specified items are displayed and the mode in which the no-specified items are displayed in the eleventh modification. According to the eleventh modification, the user is capable of recognizing which item is the specified item and which item is the no-specified item before the parameter selection.

### [Twelfth Modification]

Although the user apparatus 20 displays the parameters of the no-specified item competing with other parameters in the third mode and automatically updates the parameters when the parameter selection is terminated in the above exemplary embodiments, the method of the automatic update is not limited to the above one. For example, when a parameter of the no-specified item competing with another parameter is selected, the user apparatus 20 may automatically update the parameter to a parameter that does not compete with another parameter and may hold the parameter subjected to the update. In other words, the user apparatus 20 may immediately clear the competition, instead of clearing the competition later. However, also in this case, the user apparatus 20 does not automatically update the parameters of the specified item and automatically updates the parameters of the no-specified item.

### [Thirteenth Modification]

The present invention concerns an information processing method to realize the processes performed by the information processing apparatuses, in addition to the information processing apparatuses including the book binding apparatus 10 and the user apparatus 20. The processes include, for example, the selection assisting process illustrated in FIG. 12. In addition, the present invention concerns programs causing computers, such as the book binding apparatus 10 and the user apparatus 20, to function as the components illustrated in FIG. 4. These programs may be supplied in a mode in which the programs are stored on a recording medium, such as an optical disk, or in a mode in which the programs are downloaded into the computers via a network, such as the Internet, to install the programs for usage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a holding unit that holds parameters used in execution of a function for a plurality of items;
a determining unit that determines whether a predetermined relationship is established between the parameters of different items; and
a display controller that controls a display so as to display the parameters, the display controller causing the display to display a parameter determined by the determining unit not to have the predetermined relationship with a parameter of another item held by the holding unit in a first mode, the display controller causing the display, if a first parameter of a first item is selected by a user and is held by the holding unit and the determining unit determines that the predetermined relationship is established between the first parameter and a second parameter of a second item held by the holding unit, to display the first parameter in the first mode and to display the second parameter in a second mode different from the first mode.

2. The information processing apparatus according to claim 1,
wherein the holding unit continues to hold the first parameter which is determined by the determining unit to have the predetermined relationship but which is displayed in the first mode by the display controller unless the first parameter is reset by the user.

3. The information processing apparatus according to claim 1,
wherein the display controller terminates the display of the parameters if the determining unit determines that the predetermined relationship is not established between the parameters held by the holding unit.

4. The information processing apparatus according to claim 2,
wherein the display controller terminates the display of the parameters if the determining unit determines that the predetermined relationship is not established between the parameters held by the holding unit.

5. The information processing apparatus according to claim 1,
wherein a rank is set for each item, and
wherein, when the determining unit determines that the predetermined relationship is established between the first and second parameters, the holding unit holds the first parameter if the rank of the first item is set to be higher than that of the second item and does not hold the first parameter if the rank of the first item is set to be lower than that of the second item.

6. The information processing apparatus according to claim 5,
wherein the rank of a certain item is determined to be higher than that of an item for which a parameter is held by the holding unit after the certain item.

7. The information processing apparatus according to claim 1, further comprising:
a specifying unit that specifies the item,
wherein the holding unit holds the parameters if the first and second items are specified by the specifying unit, and
wherein the display controller controls the display if the first and second items are specified by the specifying unit.

8. The information processing apparatus according to claim 7,
wherein the specifying unit specifies the item in response to a user's operation.

9. The information processing apparatus according to claim 1,
wherein, when a parameter list of the second item is to be displayed, the display controller causes the display to display the parameter determined by the determining unit not to have the predetermined relationship with the first parameter in the first mode and to display the parameter determined by the determining unit to have the predetermined relationship with the first parameter in the second mode.

10. The information processing apparatus according to claim 9,
wherein, if a parameter displayed in the second mode in the list by the display controller is selected by the user, the holding unit does not hold the parameter, and
wherein, if a parameter displayed in the second mode in the list is selected, the display controller causes the display to display an image indicating that the parameter is not made the parameter used in the execution of the function.

11. A non-transitory computer readable medium storing a program causing a computer to execute a process comprising:
holding parameters used in execution of a function for a plurality of items;
determining whether a predetermined relationship is established between the parameters of different items; and
controlling a display so as to display the parameters, the controlling causing the display to display a parameter determined not to have the predetermined relationship with a parameter of another item that is held in a first mode, the controlling causing the display, if a first parameter of a first item is selected by a user and is held and the determining determines that the predetermined relationship is established between the first parameter and a second parameter of a second item that is held, to display the first parameter in the first mode and to display the second parameter in a second mode different from the first mode.

12. An information processing method comprising:
holding parameters used in execution of a function for a plurality of items;
determining whether a predetermined relationship is established between the parameters of different items; and
controlling a display so as to display the parameters, the controlling causing the display to display a parameter determined not to have the predetermined relationship with a parameter of another item that is held in a first mode, the controlling causing the display, if a first parameter of a first item is selected by a user and is held and the determining determines that the predetermined relationship is established between the first parameter and a second parameter of a second item that is held, to display the first parameter in the first mode and to display the second parameter in a second mode different from the first mode.

13. An information processing apparatus comprising:
a holding unit that holds a priority parameter; and
a display that displays the priority parameter held in the holding unit only with a character string and that displays a parameter competing with the priority parameter with a character string and an image,
wherein, when a parameter is selected by a user, the holding unit holds the selected parameter as the priority parameter, instead of the priority parameter held in the holding unit, and the display displays the selected parameter held in the holding unit only with a character string and displays a parameter competing with the selected parameter with a character string and an image.

14. An information processing method comprising:
holding a priority parameter; and
displaying the priority parameter that is held only with a character string and displaying a parameter competing with the priority parameter with a character string and an image,
wherein, when a parameter is selected by a user, the holding holds the selected parameter as the priority parameter, instead of the priority parameter that is held, and the displaying displays the selected parameter that is held only with a character string and displays a parameter competing with the selected parameter with a character string and an image.
